(19) United States
(12) Patent Application Publication
(10) Pub. No.: US 2016/0182489 A1
(43) Pub. Date: Jun. 23, 2016

(54) METHOD AND APPARATUS FOR ENABLING A SINGLE SIGN-ON ENABLED APPLICATION TO ENFORCE AN APPLICATION LOCK

(71) Applicant: MOTOROLA SOLUTIONS, INC, SCHAUMBURG, IL (US)

(72) Inventors: ADAM C. LEWIS, BUFFALO GROVE, IL (US); RICHARD S. PIEPHO, NAPERVILLE, IL (US); SHANTHI E. THOMAS, HOFFMAN ESTATES, IL (US)

(21) Appl. No.: 14/577,841

(22) Filed: Dec. 19, 2014

(51) Int. Cl. H04L 29/06

(52) U.S. Cl. CPC H04L 63/0815; H04L 63/083

(57) ABSTRACT

A single sign-on server associated with a single sign-on client authenticates a user of a device. Subsequent to the authenticating, the single sign-on client receives a request for an authentication token from a single sign-on enabled application operating on the device. The single sign-on client determines whether an application lock flag for the single sign-on enabled application is set. Responsive to the determining, the single sign-on client provides the authentication token to the single sign-on enabled application when the application lock flag is not set and withholds the authentication token from the single sign-on enabled application when the application lock flag is set.

### BACKGROUND OF THE INVENTION

When an execution platform, such as a computer, has an operating system lock, the execution platform may require that a user enter authentication data, such as a password or biometric information, after the operating system lock has been set. The execution platform may set the operating system lock, for example, after a predefined period of user inactivity, manually via the user, or after another predefined event. In some instances, secured data may be accessed by applications that are executed on platforms, for example, shared computing platforms, without an operating system lock. In these instances, these platforms may not be locked or otherwise disabled, for example, after a predefined period of inactivity. To ensure that the secured data is protected, the applications accessing the secured data may be required to set an application lock, wherein the application accessing the secured data is locked or otherwise disabled, for example, after a predefined period of user inactivity, manually via the user, or after another predefined event.

Consider an example where an application accesses a criminal justice information system including criminal records and other secured data. Consider also that the application is being executed on a computing device in a police vehicle and that the computing device does not have an operating system lock. To ensure that only authorized personnel can access the application and therefore access the criminal justice information system, the application may execute an application lock after a predefined period of inactivity, for example, after ten minutes of inactivity or the application may be manually locked by the officer. When the application executes the application lock, the application becomes inaccessible. To unlock the application, an authorized user needs to provide authentication data in response to prompts from the application.

A single sign-on service allows an authorized user to sign in or log-in once on a computing device. When the user initially signs on to the computing device, the user provides authentication data that is validated by the single sign-on service. At a subsequent time, when a single sign-on enabled application or service is executed on the computing device, the application or service requests an authentication token from the single sign-on service instead of independently requiring authentication data from the user. In response to each request for an authentication token, the single sign-on service provides the authentication token for the user to the requesting application or service. As such, after an authorized user signs in once to the single sign-on service, the user is provided unprompted access to single sign-on enabled applications and services (i.e., the user is provided access to single sign-on enabled applications and services without the user having to provide authentication data to each application or service).

On execution platforms where there is no operating system lock, consider a scenario where a user signs in to the single sign-on service and later one of the single sign-on enabled applications executes an application lock due, for example, to inactivity for a predefined period. Later this single sign-on application that has been locked may be terminated by the user using, for example, a task manager tool or another tool. Alternatively, the operating system may terminate the application to free up resources. The user may later restart this single sign-on enabled application, wherein once the single sign-on enabled application is restarted, the single sign-on enabled application may request an authentication token from the single sign-on service instead of independently requiring authentication data from the user. In cases where the user is still signed into the single sign-on service, in response to request for the authentication token, the single sign-on service provides the authentication token for the user to the restarted single sign-on enabled application, thereby enabling the user to gain unprompted access to the restarted application. Using this scheme, a legitimate user or an illegitimate user (for example, a user who has stolen the device which was in use by the legitimate user) may by-pass the application lock and begin using the application without providing authentication data after a locked application has been restarted.

Accordingly, there is a need for method and apparatus for allowing a single sign-on enabled application to enforce an application lock.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a system used in accordance with some embodiments.

FIG. 2 is a block diagram of a computing device used in accordance with some embodiments.

FIG. 3 is a flow diagram of a method implemented by a computing device in accordance with some embodiments.

FIG. 4 is a block diagram of a server used in accordance with some embodiments.

FIG. 5 is a flow diagram of a method implemented by a single sign-on client in accordance with some embodiments

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

Some embodiments are directed to apparatuses and methods for allowing a single sign-on enabled application to enforce an application lock even if the single sign-on application is terminated after the lock has been executed. A single sign-on server associated with a single sign-on client authenticates a user of a device. Subsequent to the authenticating, the single sign-on client receives a request for an authentication token from a single sign-on enabled application operating on the device. The single sign-on client determines whether an application lock flag for the single sign-on enabled application is set. Responsive to the determining, the single sign-on client provides the authentication token to the single sign-on enabled application when the application lock flag is not set and withholds the authentication token from the single sign-on enabled application when the application lock flag is set.

A single-sign on service, as described herein, may include a single sign-on client and an associated single sign-on server. The single sign-on client may be executed on the same platform or device as a single sign-on enabled application. The single sign-on server may be executed on back-end infrastructure. The single sign-on client may communicate with the single sign-on server on behalf of single sign-on-enabled applications. Based on information received from the single sign-on client, the single sign-on server associated with the single sign-on client may authenticate a user of a device. Subsequent to authenticating the user, when the single sign-on client receives a request for an authentication token from a single sign-on enabled application operating on the device, the single sign-on client determines whether an application lock flag for that single sign-on enabled application is set.

In order for the single sign-on client to be aware of the application lock flag status of a single sign-on enabled application, the single sign-on enabled application provides an indication or otherwise informs the single sign-on client that the single sign-on enabled application has been locked, whenever a lock event occurs at the single sign-on enabled application. Based on the indication that a lock event has occurred at the single sign-on enabled application, the single sign-on client sets an application lock flag for that single sign-on enabled application on the single sign-on client. Responsive to the single sign-on client determining whether or not the application lock flag is set for a particular single sign-on enabled application, the single sign-on client provides the requested authentication token to the single sign-on enabled application when the application lock flag is not set and withholds the authentication token from the single sign-on enabled application and prompts the user for authentication data when the application lock flag is set.

In addition, if a single sign-on enabled application that has been locked (but not terminated) is unlocked by the user after the user provides legitimate authentication data, the single sign-on enabled application provides an indication or otherwise informs the single sign-on client to clear or remove the application lock flag that is set for the single sign-on enabled application on the single sign-on client. At any later point in time, when the application associated with the cleared application lock flag requests an authentication token from the single sign-on client, the single sign-on client will provide the authentication token without prompting the user for authentication data.

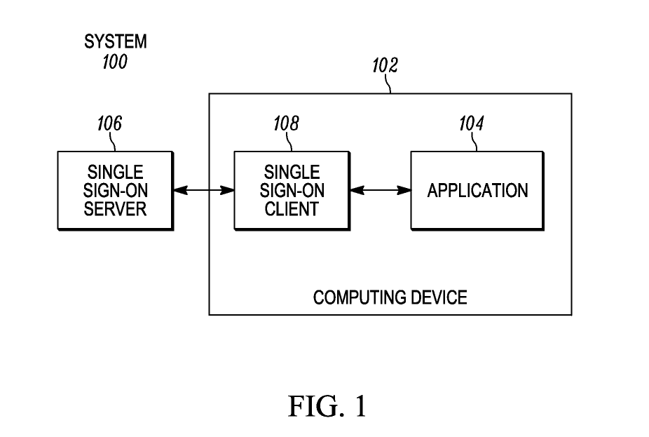

FIG. 1 is a block diagram of a system 100 used in accordance with some embodiments. System 100 includes a computing device 102 for executing one or more single sign-on enabled applications or services (only one of which is shown and described herein as application 104 or simply as an application). Computing device 102 (also referred to herein simply as device 102) may be for example, a desktop computer, a mobile device such as a mobile or portable radio, a laptop computer, or any other device that is configured to execute application 104. Device 102 may or may not be configured to execute an operating system lock, for example, after a predefined period of user inactivity or after another predefined event.

System 100 may include an identity server 106 associated with a single sign-on client 108 operating on device 102, wherein identity server 106 may be configured to authenticate a user requesting access to single sign-on enabled applications, for example, application 104, being executed on device 102. Identity server 106 is also referred to herein as a single sign-on server 106. Rather than having each single sign-on enabled application on device 102 execute its own authentication mechanism for providing access to a user of device 102, when the user initially signs in to device 102, single sign-on client 108 prompts the user for first authentication credentials (also referred to herein as first authentication data), such as a user name, password and/or biometric information. Device 102 may provide the first authentication data to server 104 and, using the authentication data provided by the user, single sign-on server 106 may validate and authenticate the user.

Subsequent to single sign-on server 106 authenticating the user, when the user tries to access a single sign-on enabled application on device 102, the single sign-on enabled application requests an authentication token from single sign-on client 108. The authentication token may be, for example, a document indicating that the user has been authenticated, when the authentication occurred, the authentication method used by single sign-on server 106 to authenticate the user, and/or a validity period of the authentication token. The authentication token may also list the single sign-on enabled applications that may use the authentication token. The authentication token may therefore be used to allow an authorized user to sign in or log-in once to device 102 and subsequently access single sign-on enabled applications on device 102, without the user being required to provide independent/separate authentication data to each application 104.

Assuming that application 104 is a single sign-on enabled application and that the user is authenticated by single sign-on server 106, at a time subsequent to the user being authenticated by single sign-on server 106, when the user tries to access application 104, application 104 receives an access request from the user. In response to the access request, application 104 requests an authentication token from single sign-on client 108 instead of requiring authentication data from the user. In response to each request for an authentication token, single sign-on client 108 determines whether or not the user has been authenticated and, when the user has been authenticated, single sign-on client 108 provides the authentication token for the user to the requesting single sign-on enabled application. This allows the user to access application 104 without the user being prompted by application 104 for authentication credentials.

Application 104 may also be configured to execute or set an application lock on application 104, for example, when there is no user activity or interaction for a predefined period, when application 104 is manually locked by the user, or based on occurrence of another predefined criterion. When application 104 sets the application lock, application 104 becomes disabled or otherwise inaccessible to the user and application 104 transmits information associated with the application lock to single sign-on client 108 for single sign-on client 108 to set an application lock flag for application 104. The application lock flag provides an indication to single sign-on client 108 that application 104 has set an application lock and instructs single sign-on client 108 to withhold sending a subsequent authentication token to application 104 while the application lock flag for application 104 is set.

At a subsequent period while the application lock flag for application 104 is set within single sign-on client 108, when the user attempts to access application 104, application 104 is configured to prompt the user for second authentication credentials (also referred to herein as second authentication data). The second authentication data may be, for example, a passcode or biometric information. The second authentication data may be the same as the first authentication data that the user provided to single sign-on server 106, or the second authentication data may be different from the first authentication data that the user provided to single sign-on server 106. If the user provides the second authentication data requested by application 104 and application 104 validates the second authentication data, then the application lock flag within the single sign-on client 108 is removed or cleared and the user is allowed to access application 104. For example, application 104 may transmit information associated with clearing the application lock flag to single sign-on client 108 for single sign-on client 108 to remove or clear the application lock flag for application 104. When the application lock flag for application 104 is cleared within single sign-on client 108, single sign-on client 108 may provide or transmit authentication tokens to application 104.

In another embodiment, while the application lock flag for application 104 is set within the single sign-on client 108, when the user attempts to access application 104, application 104 may request an authentication token from single sign-on client 108. In response to the request and based on the set application lock flag, single sign-on client 108 is configured to request the second authentication data from the user. If the user provides the second authentication data and single sign-on client 108 validates the second authentication data, single sign-on client 108 is configured to remove or clear the application lock flag for application 104. The single sign-on client 108 may then provide the authentication token to application 104 for the user to access application 104.

Consider an example where at a period subsequent to setting the application lock flag for application 104, the user terminates application 104 using a task manger tool or another tool. When application 104 is restarted and application 104 requests an authentication token from single sign-on client 108, single sign-on client 108 is configured to request the second authentication data from the user. If the user provides the second authentication data requested by single sign-on client 108 and single sign-on client 108 validates the second authentication data, single sign-on client 108 may clear or remove the application lock flag for application 104 and provide the authentication token to application 104, allowing the user access to application 104.

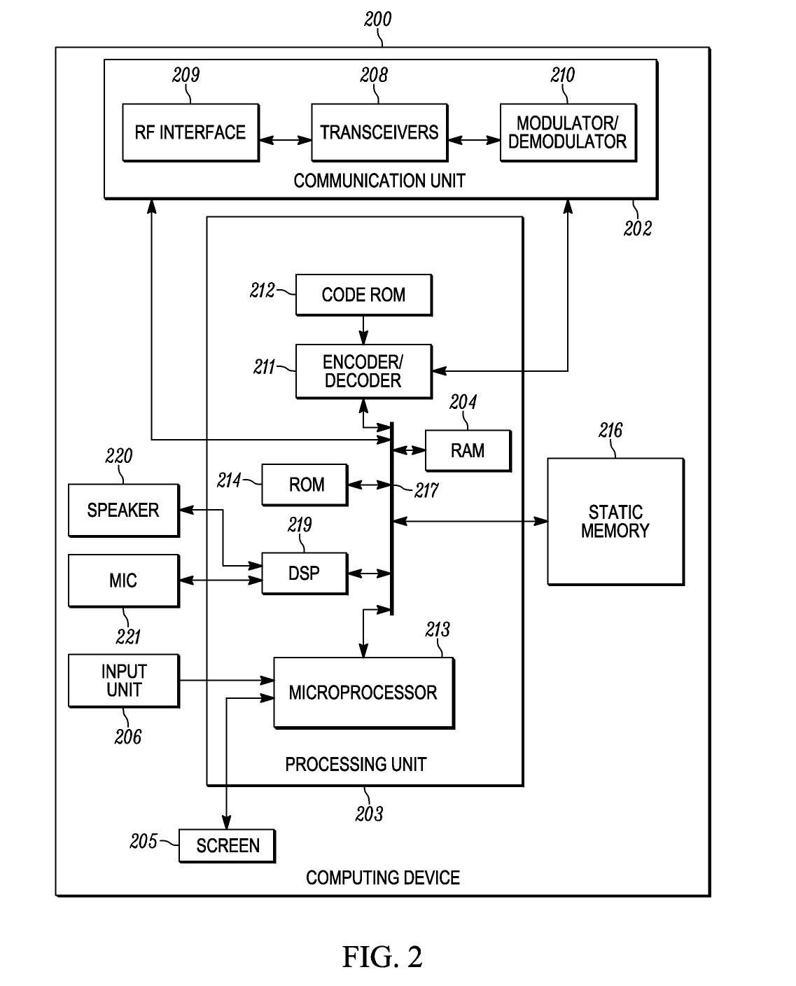

FIG. 2 is a block diagram of a computing device 200, such as device 102 of FIG. 1, used in accordance with some embodiments. In addition to application 104 and single sign-on client 108, device 200, for example, may include a communications unit 202 coupled to a common data and address bus 217 of a processor 203. Device 200 may also include an input unit (e.g., keypad, pointing device, etc.) 206, an output transducer unit (e.g., speaker) 220, an input transducer unit (e.g., a microphone) (MIC) 221, and a display screen 205, each coupled to be in communication with the processor 203.

The processor 203 may include, that is, implement, an encoder/decoder 211 with an associated code read-only memory (ROM) 212 for storing data for encoding and decoding voice, data, control, or other signals that may be transmitted or received by device 200. The processor 203 may further include one or more of a microprocessor 213 and digital signal processor (DSP) 219 coupled, by the common data and address bus 217, to the encoder/decoder 211 and to one or more memory devices, such as a ROM 214, a random access memory (RAM) 204, and a static memory 216. One or more of ROM 214, RAM 204 and static memory 216 may be included as part of processor 203 or may be separate from, and coupled to, the processor 203. The encoder/decoder 211 may be implemented by microprocessor 213 or DSP 219, or may be implemented by a separate component of the processor 203 and coupled to other components of the processor 203 via bus 217.

Communications unit 202 may include an RF interface 209 configurable to communicate with network components, and other user equipment within its communication range. Communications unit 202 may include one or more broadband and/or narrowband transceivers 208, such as an Long Term Evolution (LTE) transceiver, a Third Generation (3G) (3GGP or 3GGP2) transceiver, an Association of Public Safety Communication Officials (APCO) Project 25 (P25) transceiver, a Digital Mobile Radio (DMR) transceiver, a Terrestrial Trunked Radio (TETRA) transceiver, a WiMAX transceiver perhaps operating in accordance with an IEEE 802.16 standard, and/or other similar type of wireless transceiver configurable to communicate via a wireless network for infrastructure communications. Communications unit 202 may also include one or more local area network or personal area network transceivers such as Wi-Fi transceiver perhaps operating in accordance with an IEEE 802.11 standard (e.g., 802.11a, 802.11b, 802.11g), or a Bluetooth transceiver. The transceivers may be coupled to a combined modulator/demodulator 210 that is coupled to the encoder/decoder 211.

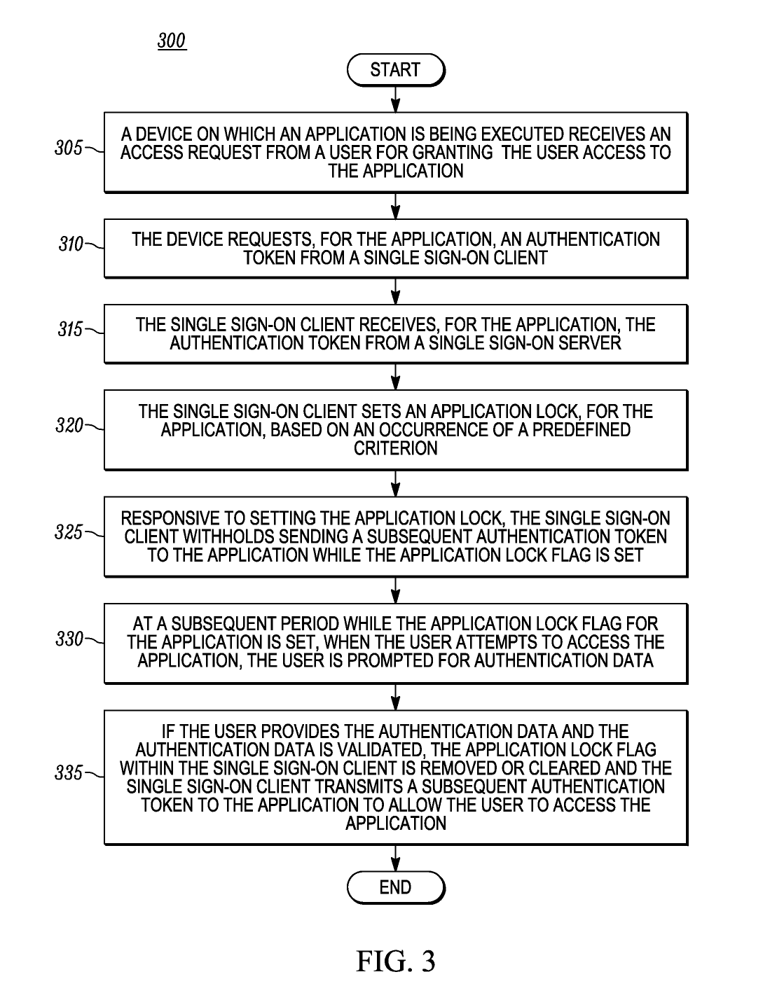

The one or more memory devices 204, 212, 214, 216 store code for decoding or encoding data such as control, request, or instruction messages, channel change messages, and/or data or voice messages that may be transmitted or received by device 200 and other programs and instructions that, when executed by the processor 203, provide for device 200 to perform the functions and operations described herein as being performed by such a device, such as the implementation of the encoder/decoder 211 and one or more of the steps set forth in FIG. 3. For example, the one or more memory devices store applications, such as application 104, and programs and instructions for implementing a single sign-on client, such as single sign client 108, that, when executed by the processor 203, cause the processor to perform the functions of such applications and single sign-on client.

FIG. 3 is a flow diagram of a method 300 implemented by a computing device, such as computing device 102, in accordance with some embodiments. At 305, the device, on which an application, such as application 104, is being executed, receives an access request from a user for granting the user access to the application. At 310, the device requests, for the application, an authentication token from a single sign-on client, such as single sign-on client 108. At 315, the single sign-on client receives, for the application, the authentication token from a single sign-on server, such as single sign-on server 106. At 320, the single sign-on client sets an application lock, for the application, based on an occurrence of a predefined criterion. At 325, responsive to setting the application lock, the single sign-on client withholds sending a subsequent authentication token to the application while the application lock flag is set.

At 330, at a subsequent period of time and while the application lock flag for the application is set, when the user attempts to access the application, the user is prompted for authentication data, for example, by the application or the single sign-on client. At 335, if the user provides the authentication data and the authentication data is validated, for example, by the requesting application or single sign-on client, the application lock flag within the single sign-on client is removed or cleared and the single sign-on client transmits a subsequent authentication token to the application to allow the user to access the application.

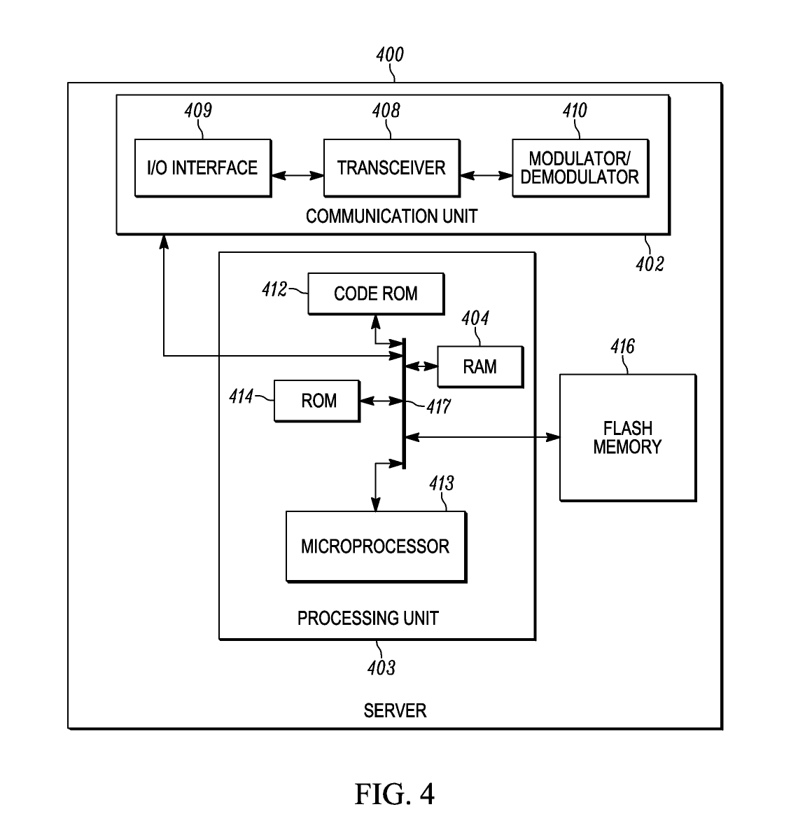

FIG. 4 is a block diagram of a server 400, such as server 106 of FIG. 1, used in accordance with some embodiments. Server 400, for example, may include a communications unit 402 coupled to a common data and address bus 417 of a processor 403. The processor 403 may include a code read-only memory (ROM) 412 for storing data for initializing system components of server 400. The processor 403 may further include a microprocessor 413 coupled, by the common data and address bus 417, to one or more memory devices, such as a read only memory (ROM) 414, a random access memory (RAM) 404, and/or a static or flash memory 416. One or more of ROM 414, RAM 404 and flash memory 416 may be included as part of processor 403 or may be separate from, and coupled to, the processor 403.

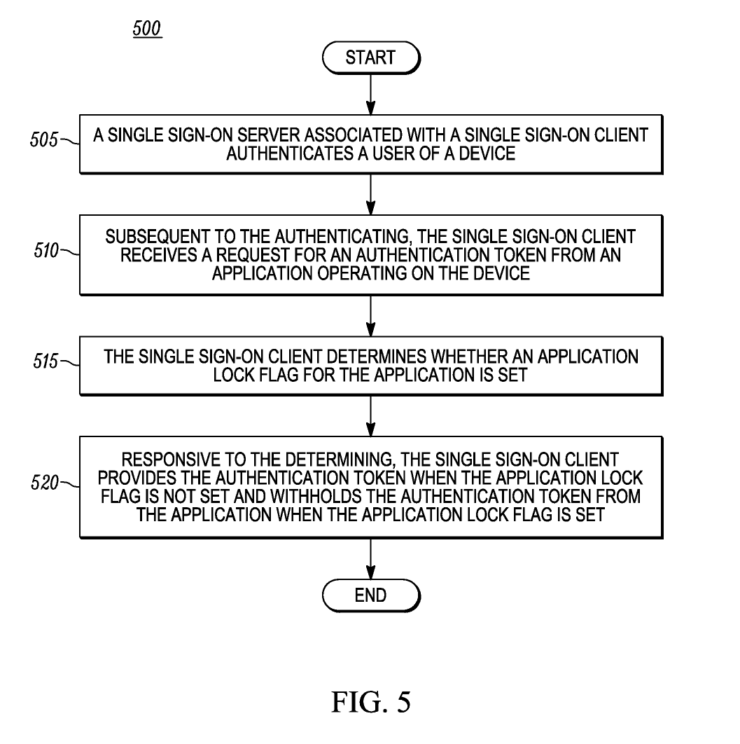

Communications unit 402 may include a wired or wireless input/output I/O interface 409 configurable to communicate with network components and other user equipment within its communication range. Communications unit 402 may include one or more broadband and/or narrowband transceivers 408, such as an Long Term Evolution (LTE) transceiver, a Third Generation (3G) (3GGP or 3GGP2) transceiver, an Association of Public Safety Communication Officials (APCO) Project 25 (P25) transceiver, a Digital Mobile Radio (DMR) transceiver, a Terrestrial Trunked Radio (TETRA) transceiver, a WiMAX transceiver perhaps operating in accordance with an IEEE 802.16 standard, and/or other similar type of wireless transceiver configurable to communicate via a wireless network for infrastructure communications. Communications unit 402 may also include one or more local area network or personal area network transceivers such as Wi-Fi transceiver perhaps operating in accordance with an IEEE 802.11 standard (e.g., 802.11a, 802.11b, 802.11g), or a Bluetooth transceiver. The transceivers may be coupled to a combined modulator/demodulator 410. The one or more memory devices 412, 414 and 416 are configured to store non-transitory computer-executable instructions to perform a set of functions such as one or more of the steps set forth in FIG. 5.

FIG. 5 is a flow diagram of a method 500 implemented by a single sign-on client, such as single sign-on client 108, in accordance with some embodiments. At 505, a device, such as device 102, having a single sign-on client, such as such as single sign-on client 108, authenticates a user of the device with a single sign-on server, such as single sign-on server 106, associated with the single sign-on client. At 510, subsequent to the authenticating, the single sign-on client receives a request for an authentication token from an application, such as application 104, operating on the device. At 515, the single sign-on client determines whether an application lock flag for the application is set. At 520, responsive to the determining, the single sign-on client provides the authentication token when the application lock flag is not set and withholds the authentication token from the application when the application lock flag is set.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method, comprising:
authenticating a user of a device, having a single sign-on client, with a single sign-on server associated with the single sign-on client;
subsequent to the authenticating, receiving, by the single sign-on client, a request for an authentication token from an application operating on the device;
determining, by the single sign-on client, whether an application lock flag for the application is set; and
responsive to the determining, providing, by single sign-on client, the authentication token when the application lock flag is not set and withholding the authentication token from the application when the application lock flag is set.

2. The method of claim 1, further comprising:
receiving, by the single sign-on client, information associated with the application lock flag from the application when the application sets an application lock; and
setting, by the single sign-on client, the application lock flag for the application.

3. The method of claim 1, wherein the application lock flag provides an indication to the single sign-on client that the application has set an application lock and wherein the application lock flag provides an indication to the single sign-on client to withhold sending a subsequent authentication token to the application while the application lock flag is set.

4. The method of claim 1, further comprising receiving, by the single sign-on client, information to clear the application lock flag subsequent to the application validating second authentication data provided by the user.

5. The method of claim 1, wherein responsive to the determining that the application lock flag is set, the method further comprises:
determining, by the single sign-on client, that the user is attempting to access the application;
requesting, by the single sign-on client, authentication data from the user;
validating, by the single sign-on client, the authentication data provided by the user; and
removing, by the single sign-on client, the application lock flag for the application in response to validating the authentication data provided by the user.

6. The method of claim 5, further comprising providing, by the single sign-on client and in response to validating the authentication data, a subsequent authentication token to the application for granting access to the application.

7. A method, comprising:
receiving, by a device on which an application is being executed, an access request from a user for granting the user access to the application;
requesting, by the device for the application, an authentication token from a single sign-on client;
receiving, by the device for the application, the authentication token from the single sign-on client; and
setting, by the device for the application, an application lock flag for the application based on an occurrence of a predefined criterion,
wherein the single sign-on client withholds transmission of a subsequent authentication token to the application while the application lock flag is set.

8. The method of claim 7, further comprising:
determining, by the application, that the application lock flag is set and that the user is attempting to access the application,
in response to determining that the application lock flag is set and that the user is attempting to access the application, requesting, by the application, authentication data from the user;
validating, by the application, the authentication data provided by the user; and
removing, by the application, the application lock flag for the application subsequent to validating the authentication data provided by the user.

9. The method of claim 8, further comprising transmitting, by the application, information associated with clearing the application lock flag to the single sign-on client for the single sign-on client to remove the application lock flag for the application.

10. A device, comprising:
a memory storing non-transitory computer-executable instructions;
a transceiver;
a processor configured to perform a set of functions in response to executing the instructions, the set of functions comprising:
authenticating a user of the device using a single sign-on client;
subsequent to the authenticating, receiving, by the single sign-on client, a request for an authentication token from an application operating on the device;
determining, by the single sign-on client, whether an application lock flag for the application is set; and
responsive to the determining, providing, by the single sign-on client, the authentication token when the application lock flag is not set and withholding the authentication token from the application when the application lock flag is set.

11. The device of claim 10, wherein the set of functions performed by the processor in response to executing the instructions further comprise:
receiving, by the single sign-on client, information associated with the application lock flag from the application when the application sets an application lock; and
setting, by the single sign-on client, the application lock flag for the application in the single sign-on client.

12. The device of claim 10, wherein the application lock flag provides an indication to the single sign-on client that the application has set an application lock and the application lock flag provides an indication to the single sign-on client to withhold sending a subsequent authentication token to the application while the application lock flag is set.

13. The device of claim 10, wherein subsequent to a setting of the application lock flag, the processor is configured to perform a set of functions in response to executing the instructions, the set of functions including:
validating authentication data provided by the user; and
in response to validating the authentication data, providing, to the single sign-on client, information to clear the application lock flag.

14. The device of claim 10, wherein responsive to the determining that the application lock flag is set, the processor is configured to perform a set of functions in response to executing the instructions, the set of functions including:
determining, by the single sign-on client, that the user is attempting to access the application;
requesting, by the single sign-on client, authentication data from the user;
validating, by the single sign-on client, the authentication data provided by the user; and
removing, by the single sign-on client, the application lock flag for the application in response to validating the authentication data provided by the user.

15. The device of claim 14, wherein the set of functions performed by the processor in response to executing the instructions further comprise:
providing, by the single sign-on client, a subsequent authentication token to the application in response to validating the authentication data for the user to access the application.
